(19) United States
(12) Patent Application Publication
(10) Pub. No.: US 2011/0196840 A1
(43) Pub. Date: Aug. 11, 2011

(54) SYSTEM AND METHOD FOR INCREMENTAL BACKUP STORAGE

(76) Inventors: Yoram BARZILAI, Raanana (IL); Inbar Mosseri, Herzelia (IL); Paul N. Weinberg, Los Angeles, CA (US)

(21) Appl. No.: 12/702,020

(22) Filed: Feb. 8, 2010

(51) Int. Cl. G06F 17/30

(52) U.S. Cl. 707/645; 707/646; 707/E17.007

(57) ABSTRACT

A system and method for incremental backup storage. The systems and methods include one or more incremental backup servers comprising a current version store configured to store data corresponding to a most recent backup and a historical version store corresponding to a prior backup to said most recent backup. One or more incremental backup clients are configured to communicate with one or more incremental backup servers . The one or more incremental backup clients each comprise a localized data set. The incremental backup server is configured to back up the localized data set of the one or more incremental backup clients.

### BACKGROUND OF THE INVENTION

1. Field of the Invention

The concepts described throughout this disclosure pertain to the field of computer systems. More particularly, but not by way of limitation, one or more embodiments enable a system and method for incremental backup storage.

2. Description of the Related Art

Computer and information systems generate and modify data, including files, directories, directory structures and other data. Backups of computer data are generated by copying the data to another location. Backups may be generated for one or more specified files, directories, memory devices, or any other set of data.

Backing up computer data is desirable to prevent loss of the data if the data is destroyed or corrupted. Data may be lost, destroyed or corrupted due to memory device failure, other computer device failure, software error, physical loss of a computer system or memory device, human error, malicious programs, and other intentional or accidental conduct. A backup of the data may be used to restore lost or corrupted data as it existed when the back up of the data was generated. The data may be restored in full or in part based on the backup version of the data. Typically, the restored data reflects the data as it existed at the time the backup was generated.

When data is backed up, one or more versions of the data are created based on the data as it existed at the time of back up. Multiple versions of the data may be stored, allowing the data to be restored to multiple different times that the backup versions were generated.

The creation of a backup requires the use of computational resources. The source data and the backup destination may be located on the same storage device and/or multiple storage devices. At least one processing device is typically involved. Furthermore, one or more communication channels, such as a communication infrastructure system bus or a network must exist between the source data and the backup destination. The use of resources to perform one or more data back ups, such as network bandwidth, storage space, processor time, and other resources, can negatively affect the usability of one or more computer systems. Additionally, backing up large amounts of data affects one or more users of any system involved in a backup due to the time and computational resources required to back up the data. Furthermore, creation of a backup requires the accessibility of such resources to successfully generate a backup of the data.

Several strategies exist to generate multiple backup versions. A full backup may be generated for each backup version. However, this strategy is the least efficient, consuming the most storage space, time and other computational resources.

Alternatively, strategies exist for the creation of incremental backups. After the creation of a full backup of the data, future changes to the data are stored as forward changes since the last backup was generated, or forward deltas. When forward deltas are stored, less computational resources are generally used. However, the most recent backup version is not readily available for restoring data because the most recent backup version is not stored. To restore data as it existed at the time of the most recent backup, the most recent backup version must be reconstructed from the full backup of the data and any forward deltas stored.

Many computer systems, such as enterprise systems, include one or more server systems and one or more client systems. Centralized data storage managed by one or more server systems is a common feature of many enterprise systems for consistency, ease of management, protection of data, and other benefits. However, localized data is often incorporated in enterprise systems on one or more client systems. The backup storage of the localized data on one or more servers combines the benefits of centralized data storage on one or more servers with the benefits of localized data storage on one or more clients. For example, enterprise systems, such as Microsoft Exchange Server®, allow personal data, including email messages, calendar events, and other personal data, to be stored on one or more servers systems and/or one or more client systems. Microsoft Outlook® is incorporated into Microsoft Exchange Server® and stores personal data in a standard format, such as Personal Storage Table (.PST) files and Offline Storage Table (.OST) files. Many customers of enterprise systems consider personal data in the system, including email messages, an important resource which is desirable to back up.

Some file formats, including formats used by Microsoft Exchange®, store multiple data elements in a single file. For example, a single .PST file includes multiple data elements corresponding to pieces of personal data, including email messages, calendar events, and other personal data. Even though a user frequently modifies individual pieces of personal data, a single .PST file is maintained since Microsoft Outlook® is configured to natively view the multiple data elements as a single file.

A .PST file on a client system includes personal data which a user may find irrelevant, such as deleted messages and junk mail. Furthermore, the local .PST file may include large amounts of white space that constitute a significant portion of the file, yet do not contain information for any individual piece of personal data stored in the .PST file. When a backup includes a full prior backup of a .PST file generated at an earlier backup time and incremental forward changes generated at one or more later backup times, the most recent backup version is not available for viewing in a native format to Microsoft Outlook®. Significant processing steps must be performed on the full prior backup and later positive deltas to calculate a most recent backup version in the native .PST format. This may be true even if it is desired that only a subset of the data elements needs to be restored.

To overcome the problems and limitations described above there is a need for systems and methods for incremental backup storage which overcomes the problems and limitations of the art as described.

### BRIEF SUMMARY OF THE INVENTION

Systems and methods for creating an incremental backup for a computer system are described which enable fast recovery all or part of the latest complete backup version, as well as individual items from previous backup versions. The latest backup may be maintained in the native item, file or file system structure, while the incremental deltas are stored as back changes from the latest version (negative deltas) rather than as forward changes from the first full backup (positive deltas). The latest backup version is kept in sync with the current version and can be quickly and easily restored rather than needing to be reconstituted from a full backup, incremental changes stored as negative deltas, or back changes from the latest backup version, and other information, such as a set of indexes. When a native item, file or file system structure is used, all of the native tools and applications may be used to directly view and recover the all or part of the backup or even individual backup items without any use of the backup or other application.

One or more embodiments of systems and methods for incremental backup storage are directed to a computer program product for generating an incremental backup stored in a tangible computer-readable medium. The computer-readable medium contains computer-executable instructions which include performing a full backup of a localized data set including one or more data elements. In one or more embodiments, the granularity of the incremental backup extends to bytes, sectors, complete or partial files, directories, or any other physical and/or logical component of stored data. The localized data set is stored in a physical memory device coupled with a client computer system. The localized data set may include personal information including email messages.

The computer-readable instructions further include identifying changed data elements in the localized data set of the client computer system. The changed data elements are new, deleted or modified data elements since a most recent backup. For example, data elements may be bytes, sectors, complete or partial files, directories, or any other physical and/or logical component of stored data. Each of the data elements may correspond to a piece of personal data, including an email message, a calendar event, or any other piece of personal data.

The computer-readable instructions further include determining if a prior version exists of the at least one of the changed data elements in a current version store including data from the most recent backup.

The computer-readable instructions further include moving any prior version of the at least one of the changed data elements to a historical version store including data from a prior backup generated before the most recent backup. The computer-readable instructions further include copying the at least one of the changed data elements to the current version store. In one or more embodiments, the computer-readable instructions further include determining a location identifier for at least one of the changed elements and modifying the location identifier for the at least one of the changed elements.

In one or more embodiments, the localized data set includes one or more .PST files including multiple email messages, and the changed data elements includes one or more email messages stored in the .PST file. The current version store may include a backup .PST file including at least a portion of the data stored in a .PST file of the localized data set.

In one or more embodiments, the computer-readable instructions further include providing at least a portion of the most recent backup using the current version store in a file format native to an application running on the client computer system. A portion of the portion of the prior backup may be provided using the current version store and the historical version store.

One or more embodiments of systems and methods for incremental backup storage are further directed to a computer-implemented method including instructions stored in a tangible computer memory medium for incremental backup storage using negative deltas. The computer-implemented method includes performing a full backup of a localized data set including a plurality of data elements, each data element including a piece of personal data. The piece of personal data may be an email message.

The localized data set is stored in a physical memory device coupled with an incremental backup client. The localized data set may include one or more .PST files. At least one email folder of the one or more .PST files is excluded from incremental backup.

The computer-implemented method further includes identifying changed data elements in the localized data set. The changed data elements include new, deleted or modified data elements since the most recent backup.

The computer-implemented method further includes determining if a prior version exists of at least one of the changed data elements in a current version store including data from a most recent backup of the localized data set. The computer-implemented method further includes moving any prior version of the at least one of the changed data elements to a historical version store including data from a prior backup generated before the most recent backup. The current version store and the historical version store are stored in at least one physical memory device coupled with a server system. The computer-implemented method further includes copying the at least one of the changed data elements to the current version store.

In one or more embodiments, the computer-implemented method further includes providing by the server system at least a portion of the most recent backup to the incremental backup client using the current version store. The most recent backup may be provided in a file format native to an application running on the incremental backup client, such as a .PST file format.

In one or more embodiments, the computer-implemented method further includes providing by the server system at least a portion of the prior backup to the incremental backup client using the current version store and the historical version store.

One or more embodiments of systems and methods for incremental data storage are further directed to a system for incremental backup storage using negative deltas. The system includes one or more incremental backup servers including a current version store configured to store data corresponding to a most recent backup and a historical version store corresponding to a prior backup to the most recent backup.

The system further includes one or more incremental backup clients configured to communicate with one or more incremental backup servers over a network connection. Each of the one or more incremental backup clients includes a localized data set. The incremental backup server is configured to back up the localized data set of the one or more incremental backup clients.

In one or more embodiments, the system further includes an email client application of the one or more incremental backup clients. The email client application views and stores personal data in a native format. The localized data set includes personal data. The localized data set may include one or more client .PST files. In one or more embodiments, the current version store includes one or more backup .PST files including at least a portion of data elements of the one or more client .PST files.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a general-purpose computer and peripherals that when programmed as described herein may operate as a specially programmed computer capable of implementing one or more systems and methods for incremental backup storage.

FIG. 2 illustrates an exemplary system in accordance with systems and methods for incremental backup storage.

FIG. 3 illustrates a block diagram of an exemplary system for incremental backup of a localized data set comprising personal data in accordance with systems and methods for incremental backup storage.

FIG. 4 illustrates a diagram of process steps to incrementally back up changed data elements in accordance with systems and methods for incremental backup storage.

FIG. 5 illustrates an exemplary user interface for a user to access stored data in accordance with systems and methods for incremental backup storage.

FIGS. 6A-B illustrate exemplary directory structures usable by a user to access stored data in accordance with systems and methods for incremental backup storage.

### DETAILED DESCRIPTION

Systems and methods for incremental backup storage will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

As used herein, the term “network” refers to any type of computer network or interconnection fabric capable of transporting data, including but not limited to Local Area Networks (LAN), Wide Area Networks (WAN), wireless networks, optical networks, distributed networks, the Internet or any combination thereof.

As used herein, the term “server” refers to any computer system configured to receive and respond to requests and from one or more computer systems, such as clients.

As used herein, the term “client” refers to any computer system capable of being configured to communicate with a server.

As used herein, the term “server application” refers to an application implemented on a server.

As used herein, the term “client application” refers to an application implemented on a client.

A server application and a client application may run on the same computer system, such that the computer system is both a server and a client. Alternatively, a server application and a client application may run on different computer systems that communicate over a network.

As used herein, the term “backup” refers to any copy made of one or more files, directories, or other locations in memory, including any combination thereof, or any process in which a backup is created.

As used herein, the term “back up” refers to the act of creating a backup.

As used herein, the term “partial backup” refers to any copy made of a portion of one or more files, directories, or other locations in memory, including any combination thereof.

As used herein, the term “incremental backup” refers to a backup generated based on one or more data elements that have changed since a prior backup, including a full backup performed for any reason, including but not limited to an initial backup, a regularly scheduled full backup, a substantial amount of changes to the data, or any other reason.

As used herein, the term “most recent backup” refers to an incremental backup most recently performed for a set of data.

As used herein, the term “prior backup” refers to one any incremental backup generated prior to the most recent backup for a set of data.

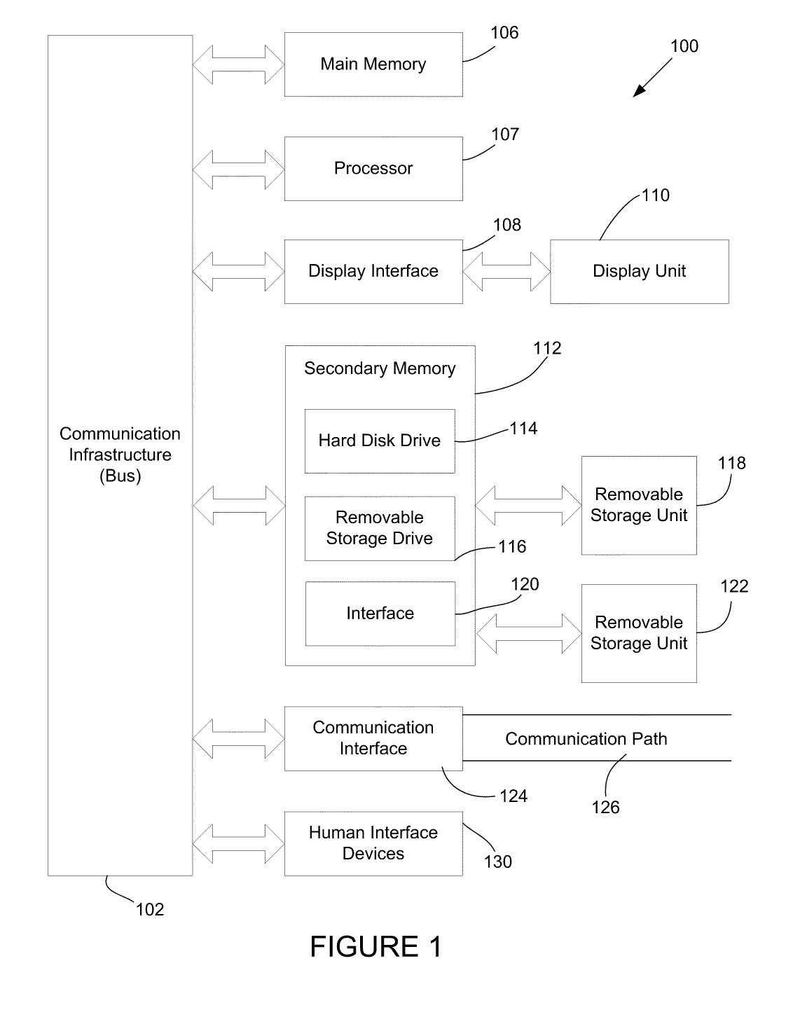

FIG. 1 diagrams a system 100 comprising a general-purpose computer and peripherals that, when programmed as described herein, may operate as a specially programmed computer capable of implementing one or more methods, apparatus and/or systems of the solution described in this disclosure. System 100 illustrates an exemplary general-purpose computer usable in any part of the systems and methods for incremental backup storage, including any client system and/or any server system that is involved in one or more methods for incremental backup storage as described in this disclosure.

Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may comprise one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may comprise, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also comprise interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), wireless networks, optical networks, distributed networks, the Internet or any combination thereof are some examples of the type of communication paths that may be utilized by the specially program computer system. Communication path 126 may comprise any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. Where a virtual machine, process, device or otherwise performs substantially similarly to that of a physical computer system, such a virtual platform will also fall within the scope of disclosure provided herein, notwithstanding the description herein of a physical system such as that in FIG. 1.

One or more embodiments are configured to enable the specially programmed computer to take the input data given and transform it into a web-based UI by applying one or more of the methods and/or processes described herein. Thus the methods described herein are able to transform a stored component into a web UI, using the solution disclosed here to result in an output of the system as a web UI design support tool, using the specially programmed computer as described herein.

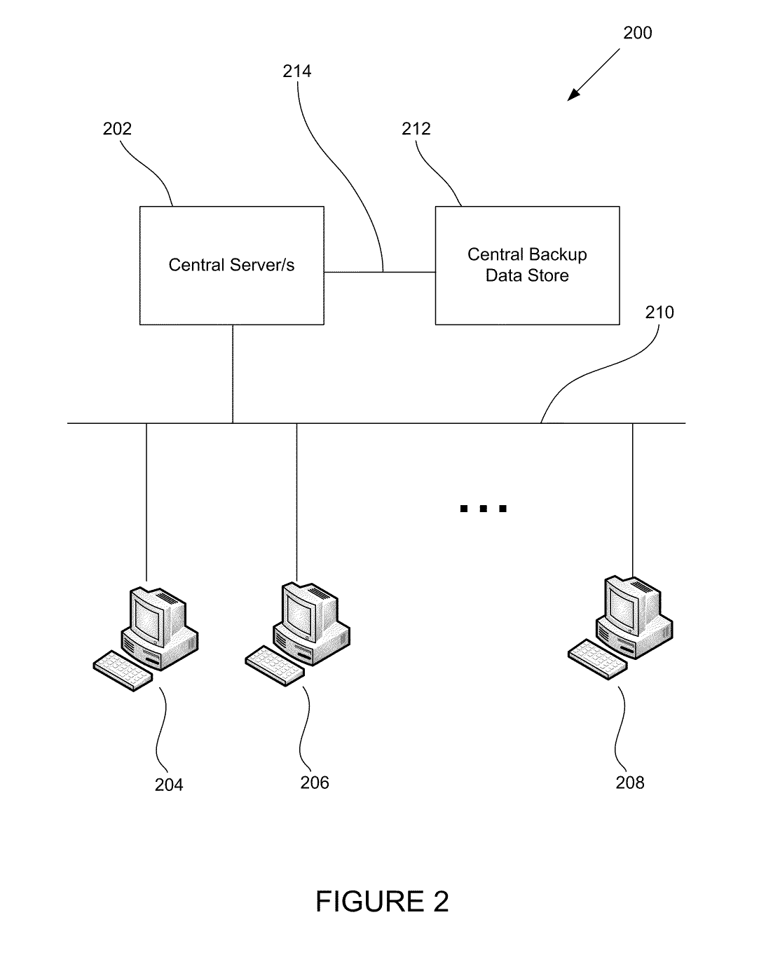

FIG. 2 illustrates an exemplary system 200 in accordance with systems and methods for incremental backup storage. System 200 includes one or more Incremental Backup Clients 204-208. At least one localized data set of each Incremental Backup Client 204-208 is backed up by Incremental Backup Server 202.

The localized data set is located on one or more storage devices connected to Incremental Backup Clients 204-208. The localized data set may be one or more files and/or one or more directories, including one or more entire storage devices. The localized data set may be specified by a default setting, a user of Incremental Backup Clients 204-208 or a user of Incremental Backup Server 202, such as an administrator. The localized data set may include personal data storage locations on Incremental Backup Clients 204-208, including but not limited to email messages and calendar events. In one or more embodiments, the localized data set is one or more Personal Storage Table (.PST) files.

Network 210 is any network that allows clients 204-208 to communicate with Incremental Backup Server 202, such as Local Area Networks (LAN), Wide Area Networks (WAN), wireless networks, optical networks, distributed networks, the Internet or any combination thereof.

Incremental Backup Server 202 is configured to communicate with one or more Incremental Backup Clients 204-208. Incremental Backup Clients 204-208 are configured to connect to Incremental Backup Server 202 to initiate an incremental backup of a localized data set for each Incremental Backup Client 204-208. The connection for incremental backup may be initiated by either Incremental Backup Server 202 or an Incremental Backup Client 204-208.

Incremental backups may be performed at a default time, a user-specified time or a time set on Incremental Backup Server 202, such as an administrator-determined time. Incremental backups may be performed on a regular schedule. In one or more embodiments, Incremental Backup Clients 204-208 are configured to initiate a backup based on at least one of a predetermined schedule, the availability of network connectivity for establishing a connection to Incremental Backup Server 202 over network 210, and an amount and/or significance of changes made to the localized data set since the most current incremental backup.

Incremental backups may be performed a localized data set including one or more files and/or one or more directories, including one or more entire storage devices. The localized data set may be specified by a default setting, a user of Incremental Backup Clients 204-208 or a user of Incremental Backup Server 202, such as an administrator. The localized data set may include personal data storage locations on Incremental Backup Clients 204-208, including but not limited to email messages and calendar events.

The generation of the incremental backup may include a full backup performed for any reason, including but not limited to an initial backup, a regularly scheduled full backup, a substantial amount of changes to the data, or any other reason. An initial full backup is performed the first time that a backup for one of Incremental Backup Clients 204-208 is generated. In addition, a regularly scheduled full backup may be performed as designated by a default setting, a user-specified setting, and/or an administrator-specified setting. Furthermore, a full backup may be performed when a substantial amount of changes have been detected since either the last full backup or the last incremental backup. If a full backup is performed based on a substantial amount of changes, a threshold may be designated by a default setting, a user-specified setting, and/or an administrator-specified setting.

In one or more embodiments, the localized data set is a complete or partial portion of a set of personal data, such as email messages, calendar events, and other personal data. A portion of the personal data that is backed up may be designated by a default setting, a user-specified setting, and/or an administrator-specified setting. For example, settings designating the location of a localized data set include a backup date range, specific folders locations to include, specific folders locations to exclude, excluding junk mail, excluding deleted items, and any other settings that define a portion of personal data for backup.

In one or more embodiments, when only a portion of personal data is backed up, Incremental Backup Server 202 incrementally stores only data necessary to reconstruct the selected personal data in a specified format. The reconstructed personal data may be viewed on an Incremental Backup Client 204-208 using a client application configured to natively view the personal data in the specified format.

In one or more embodiments, the localized data set is a complete or partial portion of one or more Personal Storage Table (.PST) files. A portion of a .PST file that is backed up may be designated by a default setting, a user-specified setting, and/or an administrator-specified setting. For example, such settings include selecting a backup date range, selecting specific folders for backup, excluding specific folders from backup, excluding junk mail, excluding deleted items, and any other settings that define a portion of a .PST file. In one or more embodiments, when only a portion of a .PST file is backed up, Incremental Backup Server 202 incrementally stores only the data necessary to reconstruct a .PST file containing the deleted items. For example, an Incremental Backup Server 202 may generate and store a backup .PST file that includes personal data, such as email messages and calendar events, selected for backup that are locally stored on an Incremental Backup Client 204-208 in a portion of a client .PST file. The reconstructed .PST file may be viewed on an Incremental Backup Client 204-208 using a client application configured to natively view personal data, such as email messages, calendar events, and other personal data, in .PST file format.

In one or more embodiments, Incremental Backup Data Store 312 stores the latest backup version and negative deltas, or back changes from the latest backup version. Back changes include files, folders and/or other data elements that are new, deleted, modified in any way, or any other change. In one or more embodiments, a placeholder is used for deleted files, folders and/or other data elements to track the deletion of the data element.

The latest backup version may be stored in a native file format, and/or directory structure resembling the format and/or structure of the localized data set on Incremental Backup Clients 204-208.

In one or more embodiments, the incremental storage of prior versions of the localized data set is based on settings indicating whether prior versions are stored and the number and/or date range of prior versions to be stored. The prior version settings may be designated by a default setting, a user-specified setting, and/or an administrator-specified setting.

Incremental Backup Data Store 212 is configured to store complete or partial incremental backups of one or more localized data sets from Incremental Backup Clients 204-208. Incremental Backup Data Store 212 resides on a memory device, such as magnetic, optical, or magnetic-optical storage systems, or any other mass storage technology that provides a repository for digital information. In one or more embodiments, Incremental Backup Data Store 212 resides in secondary memory. Incremental Backup Data Store 212 may comprise a database, including a database managed by a Database Management System (DBMS) executing on Incremental Backup Server 202.

Incremental Backup Data Store 212 is bi-directionally connected to Incremental Backup Server 202. In one or more embodiments, Incremental Backup Data Store 212 is directly connected to Incremental Backup Server 202, such as by as communication infrastructure system bus. Incremental Backup Data Store 212 may also reside in one or more other computer systems that communicate with Incremental Backup Server 202 over a network, including network 210.

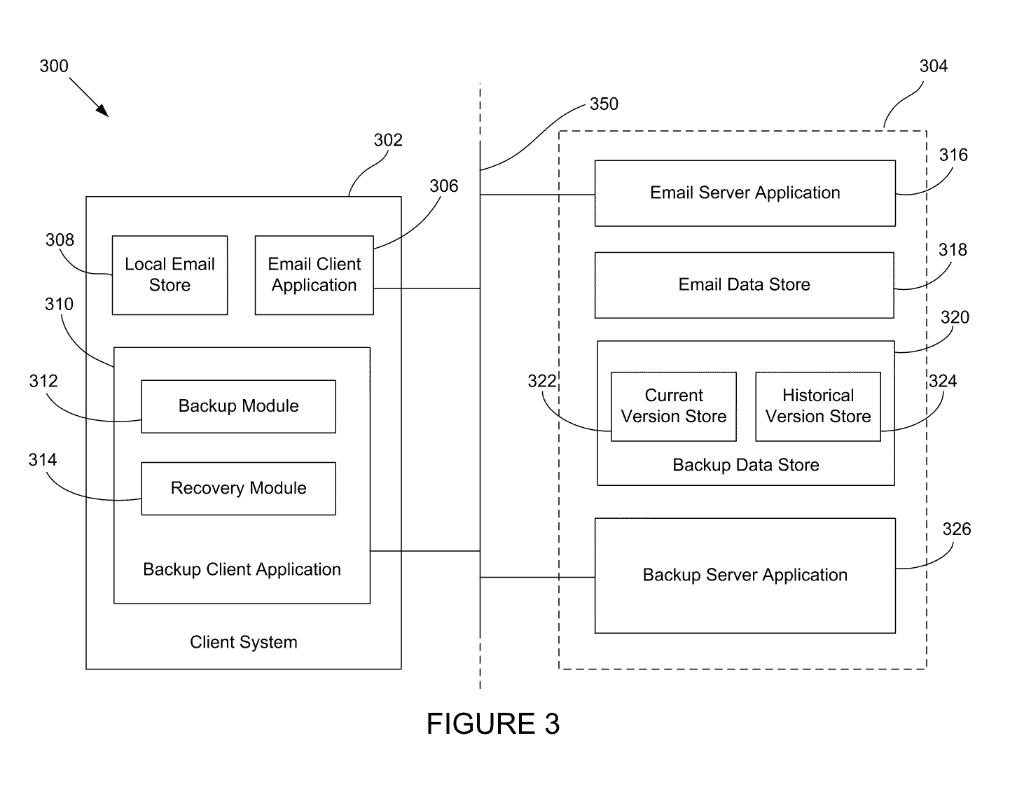

FIG. 3 illustrates a block diagram of an exemplary system 300 that provides an incremental backup solution 300 for incremental backup of a localized data set comprising email messages in accordance with systems and methods for incremental backup storage. In one or more embodiments, system 300 is an enterprise solution configured for compatibility with enterprise software.

System 300 comprises Client System 302. Client System 302 is any computer system that runs a client application configured to communicate with an email server. Client System 302 includes Email Client Application 306. Email Client Application 306 is any application used to download and/or manage email, such as any agent acting as a client to an email server. Email Client Application 306 may store personal data, such as email messages and calendar events, in one or more local .PST files. In one or more embodiments, Email Client Application 306 is configurable as a component supported in an enterprise system, such as Microsoft Outlook®.

Email Client Application 306 stores personal data such as email messages, calendar events, and any other personal data in Local Email Store 308. Local Email Store 308 may include one or more local .PST files. Local Email Store 308 resides on a memory device, such as magnetic, optical, or magnetic-optical storage systems, or any other mass storage technology that provides a repository for digital information. In one or more embodiments, Local Email Store 308 resides in secondary memory.

Email Client Application 306 communicates with Email Server Application 316 via network 350. Network 350 is any network that allows Client System 302 to communicate with one or more server applications running on one or more Server Systems 304. Network 350 includes Local Area Networks (LAN), Wide Area Networks (WAN), wireless networks, optical networks, distributed networks, the Internet or any combination thereof.

Client System 302 further includes Backup Client Application 310. Backup Client Application 310 is configured to connect to Backup Server Application 326 to initiate an incremental backup of at least a portion of Local Email Store 308 located on Client System 302. The connection for incremental backup may be initiated by either Backup Server Application 326 or Backup Client Application 310.

Incremental backups may be performed at a default time, a user-specified time or a time set on Backup Server Application 326, such as an administrator-determined time. Incremental backups may be performed on a regular schedule. In one or more embodiments, Backup Client Application 310 is configured to initiate a backup based on at least one of a predetermined schedule, the availability of network connectivity for establishing a connection to Backup Server Application 326 over network 350, and an amount and/or significance of changes made to Local Email Store 308 since the most current incremental backup.

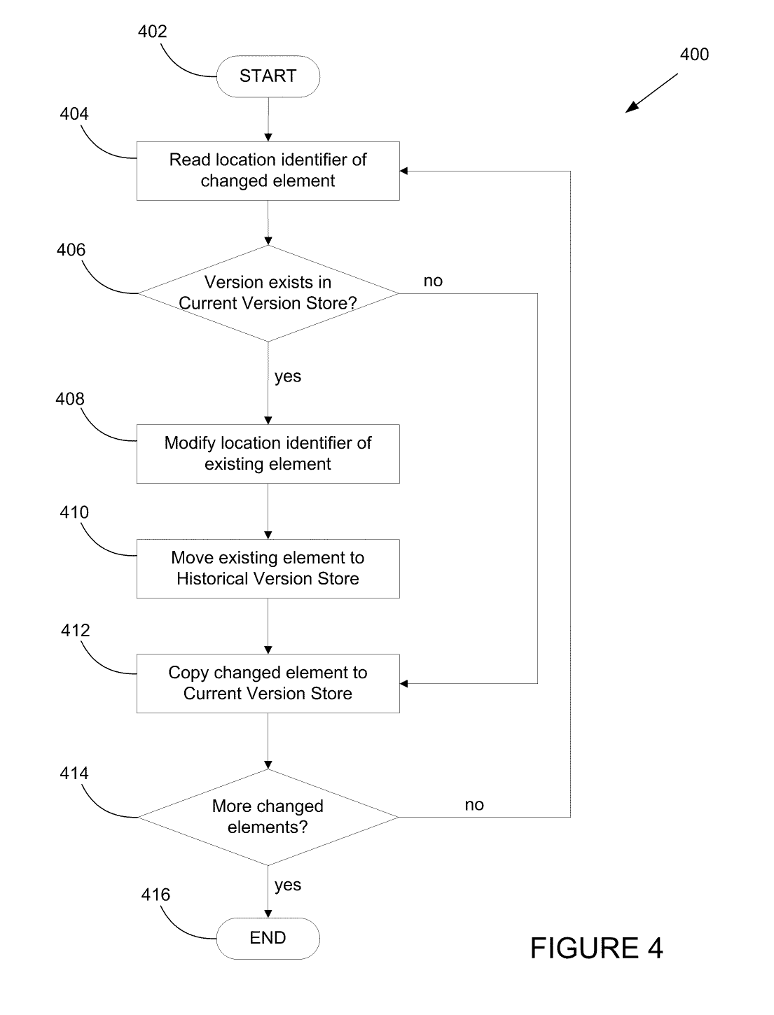

Backup Client Application 310 includes Backup Module 312 and Recovery Module 314. Backup Module 312 communicates of Backup Server Application 326 to perform an incremental backup of Local Email Store 308. FIG. 4 illustrates an exemplary process for performing an incremental backup that may be used by Backup Module 312 to perform an incremental back up of Local Email Store 308.

The generation of the incremental backup may include a full backup performed for any reason, including but not limited to an initial backup, a regularly scheduled full backup, a substantial amount of changes to the data, or any other reason. An initial full backup is performed the first time that a backup for Client System 302 is generated and stored on Server System/s 304. In addition, a regularly scheduled full backup may be performed as designated by a default setting, a user-specified setting, and/or an administrator-specified setting. Furthermore, a full backup may be performed when a substantial amount of changes have been detected since either the last full backup or the last incremental backup. If a full backup is performed based on a substantial amount of changes, a threshold may be designated by a default setting, a user-specified setting, and/or an administrator-specified setting.

In one or more embodiments, Backup Module 302 is configured to generate a personal incremental backup without connecting to Backup Server Application 326. The personal incremental backup may be stored over a network, or on a personal storage device, including a portable personal storage device such as a Universal Storage Bus (USB) memory device.

Recovery Module 314 communicates with Backup Server Application 326 to access a partial or complete backup of Local Email Store 308. Recovery Module 314 is configured to access a partial or complete backup of Local Email Store 308 stored in Backup Data Store 320 through Backup Server Application 326. Recovery Module 314 may access one or more pieces of personal data, such an email message, calendar event, or other personal data. The backup may be a complete or partial backup of the most recent version of Local Email Store 308 based on data stored in Current Version Store 322, or a prior backup version of Local Email Store 308 as reconstructed using both Current Version Store 322 and Historical Version Store 324.

In one or more embodiments, Recovery Module 314 provides access to a complete or partial backup of Local Email Store 308 through Email Client Application 306. The complete or partial backup, including the most recent backup version and/or a prior version Local Email Store, may be made available to Email Client Application 306 using a format native to Email Client Application 306, including but not limited to a .PST file containing email messages, calendar events, and/or other personal data.

System 300 further includes one or more Server System/s 304. Server System/s 304 include Email Server Application 316, Email Data Store 318, Backup Data Store 320 and Backup Server Application 326. Server System/s 304 includes one or more computer systems (i.e. servers) configured to run one or more of the elements contained within Server System/s 304 in FIG. 3, such as a DBMS and/or any other application.

Server System/s 304 include Email Server Application 316. Email Server Application 316 is any application that provides email message services to a client email application. In one or more embodiments, Email Server Application 316 supports any protocol that allows a client application to store personal data locally to a client, such as email messages, calendar events, and/or any other personal data. For example, Email Server Application 316 may support Post Office Protocol (POP3). Email Server Application 316 may also support other protocols that rely on centralized storage of personal data, such as Internet Message Access Protocol (IMAP). Email Server Application 316 includes any enterprise software that allows a client application to store personal data locally to a client, such as Microsoft Outlook®. In one or more embodiments, Email Server Application 316 stores personal data as one or more .PST files.

Email Server Application 316 accesses Email Data Store 318. Email Data Store 318 resides on a memory device, such as magnetic, optical, or magnetic-optical storage systems, or any other mass storage technology that provides a repository for digital information. In one or more embodiments, Email Data Store 318 resides in secondary memory.

Email Data Store 318 may comprise incoming messages for transmittal to one or more Email Client Application 306 by Server System/s 304 before Email Client Application 306 requests to download the incoming messages. When a client chooses to use IMAP to communicate with Email Server Application 316, Email Data Store 318 stores centralized personal data files, such as email messages, calendar events, and/or other personal data.

System 300 further includes Backup Server Application 326. At least one complete or partial Local Email Store 308 of Client System 302 is backed up by Backup Server Application 326. Backup Server Application 326 communicates with Backup Client Application 310 via network 350.

Backup Server Application 326 stores one or more backups of Local Email Store 308 in Backup Data Store 320. Backup Data Store 320 resides on a memory device, such as magnetic, optical, or magnetic-optical storage systems, or any other mass storage technology that provides a repository for digital information. In one or more embodiments, Backup Data Store 320 resides in secondary memory.

Backup Data Store 302 stores one or more complete or partial backup of Local Email Store 308, including the most recent backup version and/or a prior version of Local Email Store 308. Backup Server Application 326 incrementally generates a backup of Local Email Store 308, including the most recent backup and/or a prior version backup, available to Client system 302, such as through Backup Client Application 310 or Email Client Application 306. In one or more embodiments, Backup Server Application 326 makes a complete or partial backup available in a format native to Email Client Application 306, including but not limited to a .PST file containing email messages, calendar events, and/or other personal data.

In one or more embodiments, Backup Server Application 326 stores a complete or partial portion of a Local Email Store 308, such as email messages, calendar events, and other personal data. A portion of Local Email Store 308 that is backed up may be designated by a default setting, a user-specified setting, and/or an administrator-specified setting. For example, such settings include selecting a backup date range, selecting specific folders for backup, excluding specific folders from backup, excluding junk mail, excluding deleted items, and any other settings that define a portion of personal data for backup.

In one or more embodiments, Backup Server Application 326 incrementally stores the data necessary to reconstruct the selected personal data in a specified format. When only a selected portion of Local Email Store 308 is backed up, personal data outside of the selected portion are left out of Backup Data Store 320. Incremental changes made since the most recent of Local Email Store 308 are stored as back changes in Historical Version Store 324, while Current Version Store 322 is configured to store the data reflecting the most recent backup of Local Email Store 308.

In one or more embodiments, Backup Server Application 326 incrementally stores data elements necessary to reconstruct the personal data in a native format of Email Client application 306 using Current Version Store 322 and/or Historical Version Store 324. The reconstructed personal data may be viewed using an Email Client Application 306 configured to natively view the personal data. In one or more embodiments, only Current Version Store 322 is necessary to reconstruct the personal data from the most recent backup.

In one or more embodiments, the Local Email Store 308 is one or more Personal Storage Table (.PST) files. A portion of a .PST file that is backed up may be designated by a default setting, a user-specified setting, and/or an administrator-specified setting. For example, such settings include selecting a backup date range, selecting specific folders for backup, excluding specific folders from backup, excluding junk mail, excluding deleted items, and any other settings that define a portion of a .PST file.

In one or more embodiments Backup Server Application 326 incrementally stores data elements necessary to reconstruct a .PST file in Current Version Store 322 and Historical Version Store 324. Incremental changes made since the most recent of Local Email Store 308 are stored as back changes in Historical Version Store 324. Current Version Store 322 is configured to store the data reflecting the most recent backup of Local Email Store 308.

Backup Server Application 326 is further configured to provide Backup Client Application 310 with access to a complete or partial backup stored in Backup Data Store 320. The reconstructed .PST file may be viewed using an Email Client Application 306 configured to natively view personal data, such as email messages, calendar events, and other personal data, in .PST file format. The backup may be a complete or partial backup of the most recent version of Local Email Store 308 based on data stored in Current Version Store 322, or a prior backup version of Local Email Store 308 as reconstructed using both Current Version Store 322 and Historical Version Store 324.

When a most recent backup is requested, Backup Server Application 326 is configured to provide the most recent backup using Current Version Store 322 without the need to access Historical Version Store 324. In one or more embodiments, Current Version Store 322 provides the most recent backup directly to a client application requesting access to the most recent backup. In one or more embodiments, Historical Version Store stores negative deltas, or back changes from the latest version stored in Current Version Store 322. Back changes include files, folders and/or other data elements that are new, deleted, modified in any way, or any other change. In one or more embodiments, a placeholder is used for deleted files, folders and/or other data elements to track the deletion of the data element.

In one or more embodiments, the incremental storage of prior versions of Local Email Store 308 is based on settings indicating whether prior versions are stored and the number and/or date range of prior versions to be stored. The prior version settings may be designated by a default setting, a user-specified setting, and/or an administrator-specified setting.

Current Version Store 322 may store the complete or partial backup of Local Email Store in a format native to Email Client Application 306, such as .PST format. Current Version Store 322 may also store the complete or partial backup of Local Email Store 308 in any other format, including a compressed format. Backup Server Application 326 may also reconstruct a complete or partial backup in the native format from Current Version Store 322 when a backup is requested.

When a prior backup version is requested, Backup Server Application 326 provides a complete or partial backup from Current Version Store 322 and Historical Version Store 324. In one or more embodiments, Backup Server Application 326 is configured to store the incremental backup storage data necessary to reconstruct a prior backup version. Backup Server Application 326 may also be configured to reconstruct the prior backup version using data stored in Current Version Store 322 and Historical Version Store 324. The reconstruction of the complete or partial backup may be provided in a format native to Email Client Application 306.

FIG. 4 illustrates a diagram of process steps to incrementally back up changed data elements in accordance with systems and methods for incremental backup storage. In one or more embodiments, a server application configured to incrementally back up one or more personal data files local to a client executes the steps of process 400 to incrementally back up the personal data files.

In one or more embodiments, a most recent backup store, such as Current Version Store 322, reflects the latest version of the local personal data files. Past versions of the local personal data files are stored as back changes, such as in Historical Version Store 324.

Process 400 incrementally backs up one or more data elements that have changed since the most recent backup. Changes include files that are new, deleted, modified in any way, or any other change. Methods for identifying changed items since a previous time and date are known in the art. One of ordinary skill in the art would appreciate that any method for identifying changed items that is compatible with the incremental backup system may be used to identify changed elements.

Process 400 begins at step 402. Processing continues to step 404, where a location identifier of a changed element from the one or more changed elements is read. Elements stored using the incremental backup system are accessible using location identifiers. Location identifiers may be managed using any method known in the art for managing and tracking data stored in memory. In one or more embodiments, a location identifier corresponds to a file or a portion of a file, such as a portion of a .PST file. A location identifier may correspond to a piece of personal data, such as an email message, a calendar event, or any other personal data.

Processing continues to decision step 406, where it is determined whether a version of the changed element exists in the most recent backup store, such as Current Version Store 322. The most recent backup store may store the complete or partial backup of the localized data set in a format native to a client application, including email clients that use the .PST format. In one or more embodiments, the client application is Microsoft Outlook®. The most recent backup store may also store the complete or partial backup of the localized data set in any other format, including a compressed format.

If a version of the changed element does not exist in the most recent backup store, processing continues to step 412, where the changed element is copied to the most recent backup store.

Otherwise, if the changed element exists in the most recent backup store, processing continues to step 408, where the location identifier of the existing element is modified.

Processing continues to step 410, where the existing element is moved to a past version backup store, such as Historical Version Store 324. The past version backup store includes negative deltas, or back changes from the latest backup version. In one or more embodiments, the incremental storage of prior versions is based on settings indicating whether prior versions are stored and the number and/or date range of prior versions to be stored. The prior version settings may be designated by a default setting, a user-specified setting, and/or an administrator-specified setting.

Processing continues to step 412, where the changed element is copied to the most recent backup store.

Processing continues to decision step 414, where it is determined whether more changed elements exist in the localized data set. If more changed elements exist in the localized data set, processing continues to step 404. Otherwise, processing continues to step 416, where process 400 terminates.

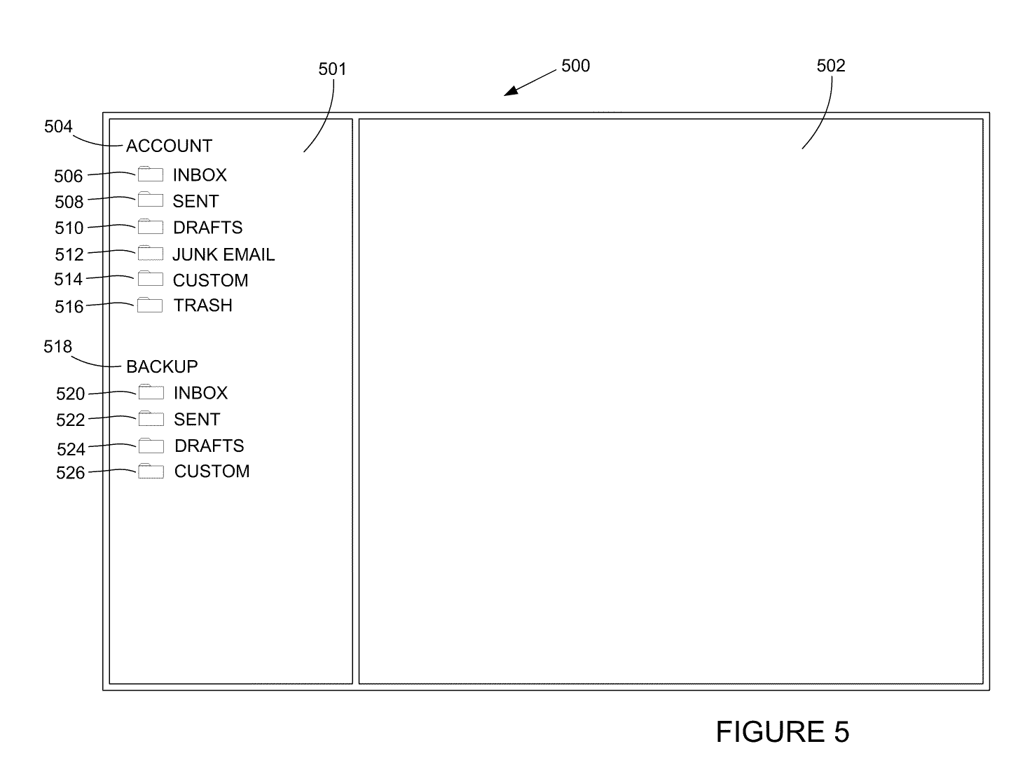

FIG. 5 illustrates an exemplary user interface 500 for a user to access stored personal data in accordance with systems and methods for incremental backup storage. User interface 500 may be provided by an incremental backup client to allow a user access to files stored in the incremental backup, including the most recent backup version and prior backup versions of one or more data elements designated for incremental backup. In one or more embodiments, user interface 500 is provided by an email client application with access to the incremental backup data in a format native to the email client application.

User interface 500 includes one or more panels 501-502. Browsing panel 501 displays a file and/or directory structure. For example, browsing panel 501 may display a directory structure internal to one or more files for storing personal data, such as email messages, calendar events, and other personal data. Browsing panel 501 may display an email message directory structure internal to one or more files for storing personal data, such as email messages, calendar events, and other personal data. In one or more embodiments, browsing panel 501 displays a directory structure internal to one or more .PST files.

Account directory 504 is a directory structure corresponding to one or more personal files for one or more user accounts. In one or more embodiments, the personal files are one or more .PST files. Account directory 504 includes message folders 506-516.

Backup directory 518 is a directory structure corresponding to a backup of one or more personal files for one or more user accounts. In one or more embodiments, the one or more personal files are one or more .PST files. In one or more embodiments, the most recent backup is stored in a native format of a client application, making the most recent backup readily available to the client application. Alternatively, the most recent backup may be stored in another format, including a compressed format, and readily converted to the native format of a client application without the need to account for negative deltas.

Backup directory 518 includes message folders 520-526. Backup directory 518 as shown corresponds to a partial backup of account directory 504. The files, directories, or other locations selected for backup may correspond to a default setting, a user-specified setting, and/or an administrator-specified setting.

Account directory 504 and backup directory 518 are shown in FIG. 5 to illustrate that an incremental backup may be stored and/or provided in a format native to an email client, such as the .PST format used by Microsoft Outlook®. However, one of ordinary skill in the art would appreciate that the invention may be practiced independently from any email client or format, whether or not an incremental backup includes personal data such as email messages or calendar data.

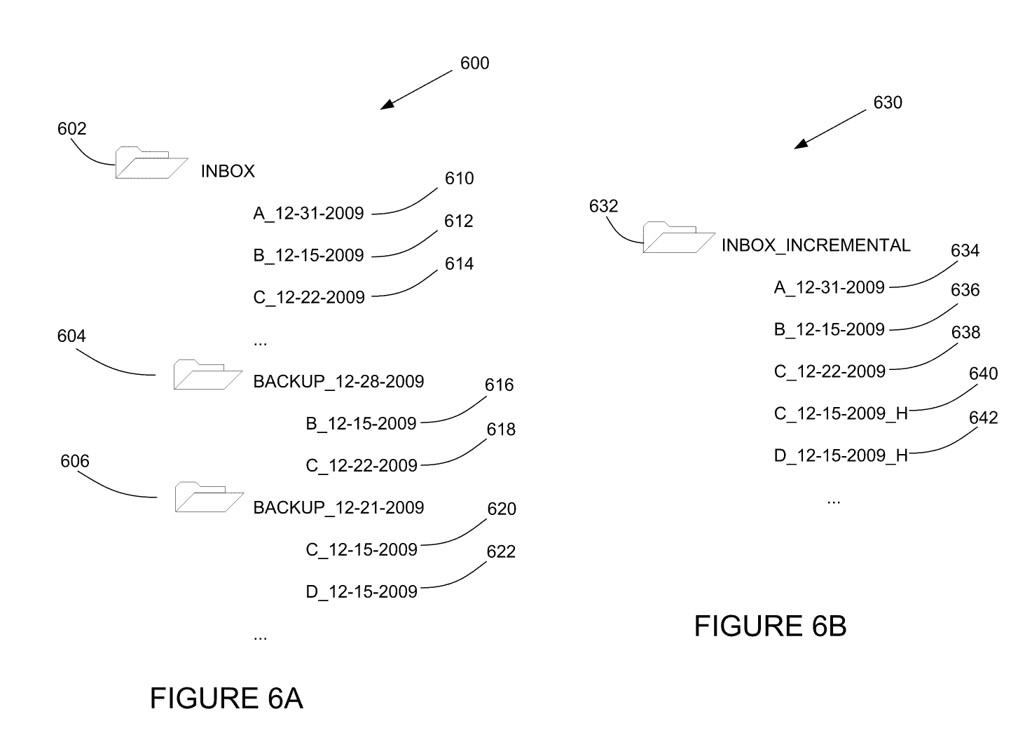

FIGS. 6A-B illustrate exemplary directory structures for displaying incremental backup data in accordance with systems and methods for incremental backup storage. The incremental backup may be organized to reflect the directory structure. In one or more embodiments, the directory structure is reflected in a .PST file which includes data elements selected for backup. One of ordinary skill in the art would appreciate that 600 and 630 are exemplary directory structures for presenting incrementally stored data, and that any method for performing and presenting one or more data elements stored in an incremental backup as disclosed falls within the scope and spirit of the invention.

FIG. 6A illustrates directory structure 600. Directory structure 600 organizes historical back up versions by backup date. Data elements 610-622 are separate data elements, such as files, folders, portions of files, email messages, calendar events, and/or any other data element compatible with systems and methods for incremental backup storage.

Directory structure 600 includes a selected directory 602. Selected directory 602 is a location selected for incremental backup. Directory structure further includes a plurality of data elements 610-622, of which one or more versions of A-D are shown. Data element A was created on Dec. 31, 2009. Data element B was created on Dec. 15, 2009. Data element C was created on Dec. 15, 2009 and modified on Dec. 22, 2009. Data element D was deleted after the incremental backup of Dec. 21, 2009.

Incremental backup directory 606 reflects a incremental backup of Dec. 21, 2009. Incremental backup directory 606 includes data elements C 620 and D 622 as present in selected directory 602 on Dec. 21, 2009.

Incremental backup directory 604 reflects a incremental backup of Dec. 28, 2009. Incremental backup directory 606 includes data element B 616, created after the incremental backup of Dec. 21, 2009. Incremental backup directory 606 also includes data element C 618, as present in selected directory 602 on Dec. 28, 2009, as modified.

FIG. 6B illustrates directory structure 630. Directory structure 630 organizes historical back up versions based on the original location of data elements, such as files, folders and/or any other data element. Data elements 634-642 are separate data elements, such as files, folders, portions of files, email messages, calendar events, and/or any other data element compatible with systems and methods for incremental backup storage.

Directory structure 630 includes a selected directory 632. Selected directory 632 is a location selected for incremental backup. Directory structure further includes a plurality of data elements 634-642, of which one or more versions of A-D are shown. Data element A was created on Dec. 31, 2009. Data element B was created on Dec. 15, 2009. Data element C was created on Dec. 15, 2009 and modified on Dec. 22, 2009. Data element D was deleted after the incremental backup of Dec. 21, 2009.

After a backup of selected directory 632 as shown, a current version data store of selected directory 632 would include data elements 634-638, corresponding to the elements present in selected directory 632 at the time of the incremental backup. A historical version data store would include data elements 640-642, corresponding to negative deltas, or back changes from the latest backup version.

While the invention herein disclosed has been described by means of specific embodiments and applications thereof, numerous modifications and variations could be made thereto by those skilled in the art without departing from the scope of the invention set forth in the claims.

What is claimed is:

1. A computer program product for generating an incremental backup stored in a tangible computer-readable medium comprising computer-executable instructions comprising:
performing a full backup of a localized data set comprising one or more data elements, wherein said localized data set is stored in a physical memory device coupled with a client computer system;
identifying changed data elements in said localized data set of said client computer system, wherein said changed data elements are new, deleted or modified data elements since a most recent backup;
determining if a prior version exists of said at least one of said changed data elements in a current version store comprising data from said most recent backup;
moving any prior version of said at least one of said changed data elements to a historical version store comprising data from a prior backup generated before said most recent backup; and
copying said at least one of said changed data elements to said current version store.

2. The computer program product of claim 1, wherein said computer-executable instructions further comprise:
determining a location identifier for at least one of said changed elements; and
modifying said location identifier for said at least one of said changed elements.

3. The computer program product of claim 1, wherein said localized data set comprises personal information comprising email messages.

4. The computer program product of claim 1, wherein each of said data elements corresponds to a piece of personal data.

5. The computer program product of claim 1, wherein each of said data elements corresponds to an email message.

6. The computer program product of claim 1, wherein said localized data set comprises one or more .PST files comprising multiple email messages and said changed data elements comprises one or more email messages stored in said .PST file.

7. The computer program product of claim 1, wherein said current version store comprises a backup .PST file comprising at least a portion of said data stored in a .PST file of said localized data set.

8. The computer program product of claim 1, wherein said computer-executable instructions further comprise providing at least a portion of said most recent backup using said current version store,
wherein said most recent backup is provided in a file format native to an application running on said client computer system.

9. The computer-implemented method of claim 1, further comprising providing at least a portion of said prior backup using said current version store and said historical version store.

10. A computer-implemented method comprising instructions stored in a tangible computer memory medium for incremental backup storage using negative deltas, said method comprising:
performing a full backup of a localized data set comprising a plurality of data elements, each data element comprising a piece of personal data, wherein said localized data set is stored in a physical memory device coupled with an incremental backup client;
identifying changed data elements in said localized data set;
determining if a prior version exists of at least one of said changed data elements in a current version store comprising data from a most recent backup of said localized data set;
moving any prior version of said at least one of said changed data elements to a historical version store comprising data from a prior backup generated before said most recent backup; and
copying said at least one of said changed data elements to said current version store,
wherein said current version store and said historical version store are stored in at least one physical memory device coupled with a server system.

11. The computer-implemented method of claim 10, wherein said piece of personal data is an email message.

12. The computer-implemented method of claim 11, wherein said localized data set comprises one or more .PST files.

13. The computer-implemented method of claim 12, wherein at least one email folder of said one or more .PST files is excluded from incremental backup.

14. The computer-implemented method of claim 10, further comprising providing by said server system at least a portion of said most recent backup to said incremental backup client using said current version store,
wherein said most recent backup is provided in a file format native to an application running on said incremental backup client.

15. The computer implemented method of claim 14, wherein said file format native to said application is a .PST file format.

16. The computer-implemented method of claim 10, further comprising providing by said server system at least a portion of said prior backup to said incremental backup client using said current version store and said historical version store.

17. The computer-implemented method of claim 10, wherein said changed data elements comprise new, deleted or modified data elements since said most recent backup.

18. A system for incremental backup storage using negative deltas, said system comprising:
one or more incremental backup servers comprising a current version store configured to store data corresponding to a most recent backup and a historical version store corresponding to a prior backup to said most recent backup; and
one or more incremental backup clients configured to communicate with one or more incremental backup servers over a network connection, said one or more incremental backup clients each comprising a localized data set;
wherein said incremental backup server is configured to back up said localized data set of said one or more incremental backup clients.

19. The system of claim 18, wherein said system further comprises an email client application of said one or more incremental backup clients, wherein said email client application views and stores personal data in a native format, wherein said localized data set comprises personal data.

20. The system of claim 19, wherein said localized data set comprises one or more client .PST files and wherein said current version store comprises one or more backup .PST files comprising at least a portion of data elements of said one or more client .PST files.
